(19) United States
(12) Patent Application Publication
(10) Pub. No.: US 2023/0356259 A1
(43) Pub. Date: Nov. 9, 2023

(54) Applicator and Operating Procedure or Using the Applicator According to the Invention

(71) Applicant: ATN Hölzel GmbH, Oppach (DE)

(72) Inventors: Uwe Schmidt, Ebersbach-Neugersdorf (DE); Oliver Roschke, Waldhufen (DE); Bernd Scheibe, Oppach (DE); Jörg Tausche, Steinigtwolmsdorf (DE)

(21) Appl. No.: 18/143,644

(22) Filed: May 5, 2023

(30) Foreign Application Priority Data
May 6, 2022 (DE) 102022111396.5

(51) Int. Cl. B05C 17/005; B65D 81/32; B01F 35/71; B01F 25/4314; B01F 25/431

(52) U.S. Cl. CPC B05C 17/00559; B05C 17/0052; B65D 81/325; B01F 35/7161; B01F 35/7162; B01F 35/71805; B01F 25/43141; B01F 25/431971; B01F 25/4317; B01F 2101/36

(57) ABSTRACT

An improved applicator and a method for applying two or more components which can be mixed together. They are intended to effectively prevent unintentional and unintentional mixing of the components at the discharge orifices and any associated uncontrolled or undesirable reaction of the components with each other during downtime of the applicator. The applicator/application device (1) for the application of at least two components can be mixed with one another, comprising coaxially arranged one within the other component feeds (2, 3) with the component feeds (2a, 3a) for the respective at least two components and component discharge orifices (2b, 3b) associated with the component feeds (2, 3),

### CROSS REFERENCE TO RELATED APPLICATIONS

This application claims the priority of DE 102022111396.5 filed on 2022 May 6; this application is incorporated by reference herein in its entirety.

### BACKGROUND

The invention relates to an applicator for applying at least two components mixable with one another to an object. In particular, the components are viscous materials or fluids, such as pasty components or adhesives. Viscous materials or fluids include both high viscosity and low viscosity materials or fluids, to which also belong pasty materials or fluids such as pasty components or pasty adhesives. Components also include component mixtures. Likewise, adhesives also include adhesive mixtures.

Furthermore, the invention relates to an operating procedure or using the applicator according to the invention, by means of which the application of two or more components mixable with one another is made.

The patent DE 10 2008 039 952 A1 describes a process at which two adhesives can be applied simultaneously from a coaxial nozzle. Among other things, it is provided that one adhesive is enclosed within the other adhesive, i.e. by this other adhesive, or that one adhesive is partially applied to the lateral surface of the other adhesive. Furthermore, it reveals the parallel side-by-side application of the two adhesives so that two adhesive tracks are adjacent to one another. It is not disclosed that the adhesives can be applied continuously in a track or line one after the other or alternately.

From the patent DE 198 80 257 B4, application nozzles or application needles with at least a first and a second channel are known, whereby for the formation of preferred profile shapes during the application of the sealing and shielding profile, an application needle/nozzle is used in which at least a part of the first channel circumference is surrounded by the second channel. Thus, an application needle or nozzle may be used in which the first channel has a substantially circular cross-section and is concentrically surrounded by the second channel. However, the aim of this device is to form a shielding profile from two or more different components, which are elastic hardening but optimized for different functions in a single parallel application step, whereas one component is the carrier of the other component. The discharge openings end in one plane.

The patent DE 100 46 557 B4 discloses a coaxial nozzle in which a first material is also directed towards a material stream of a second material and discharged at the discharge opening so that the second material stream completely surrounds the first material stream. In this case, the respective discharge openings for the materials are arranged at a distance from one another, whereby the distance is variably adjustable, and the coaxially inner discharge opening for the first material flow is arranged inside the nozzle or upstream of the discharge opening for the second material flow.

The patent EP 0 410 701 A2 also discloses a coaxial nozzle in which a first material is also directed towards a material flow of a second material, whereby a silicone hose is guided through a nozzle body up to a discharge opening so that the second material flow completely surrounds the first material flow.

The patent DE 1 085 307 B also discloses a coaxial nozzle discharging at least two pastes as a joint stream from a container, wherein the pastes are accommodated side by side.

The patent WO 2005/095225 A1 also discloses a coaxial nozzle dispensing from a container with separate material chambers two pasty components in the correct necessary ratio as a joint stream.

The EP 1 191 999 B1 discloses a coaxial nozzle in which the respective coaxially inner discharge openings for the material flow are arranged inside the nozzle and upstream of the respective coaxially outer discharge opening for the further material flow.

### SUMMARY

The invention's purpose is to provide an improved applicator and a method for applying two or more components which can be mixed together. In particular, the invention is intended to effectively prevent unintentional and unintentional mixing of the components at the discharge orifices and any associated uncontrolled or undesirable reaction of the components with each other during downtime of the applicator. 1. Applicator/application device (1) for the application of at least two components which can be mixed with one another, comprising coaxially arranged one within the other component feeds (2, 3) with the component feeds (2a, 3a) for the respective at least two components and component discharge orifices (2b, 3b) associated with the component feeds (2, 3),
where
   an outer feeding cavity (2) as the first component feed (2) to the associated 10 component discharge orifice (2b) for providing the first component, and
   an inner feeding cavity (3) is provided as a second component feed (3) to the associated component discharge orifice (3b) for providing the second component,
   wherein the inner feeding cavity is enclosed by an inner feeding tube (3c) disposed in the 15 outer feeding cavity (2) and is connected to a cavity wall (2c) of the outer feeding cavity (2) with a separation distance and
a valve rod (6) which can move in the axial direction and is connected to an actuator (5) is arranged in the inner feeding tube (3c), wherein the valve rod (6) and/or the valve rod tip (6a) thereof corresponds with a valve seat (7) arranged at the component discharge orifice (3b) of the 20 inner feeding tube (3) and the valve rod (6) or the valve rod tip (6a), respectively, forms a valve (8) with the valve seat (7) and the inner feeding cavity (3) is formed between the inner feeding tube (3c) and the valve rod (6) and
a 25 mixing device (9) is arranged downstream of the component discharge orifices (2b, 3b) of the feeding cavities (2, 3).

### DETAILED DESCRIPTION

The invention's purpose is to provide an improved applicator and an operating procedure or using an applicator for two or more components which can be mixed together. In particular, the invention is intended to effectively prevent unintentional and uncontrolled mixing of the components at the discharge orifices and any associated uncontrolled or undesirable reaction of the components with each other during downtime of the applicator.

The invention relates to an applicator for applying at least two components mixable with each other and ultimately mixed, for example as a bead or onto a surface.

Preferably, it is provided that the two components react with each other immediately upon or after mixing and thus form a two-component mixture, for example a two-component adhesive or a two-component silicone.

The applicator according to the invention for the application of at least two components mixable with one another comprises at least two component feeds arranged coaxially one inside the other, with component feeds for supplying the respective components and with component discharge orifices assigned or connected to the component feeds or arranged in or on the component feeds. The components are thus conveyed from the component feeds through the component feeds to the component discharge orifices.

At least, two component feeds are each designed as feeding cavities, i.e. as hollow spaces enclosed by at least a walling, for example, of a tube.

Cylindrical, angular, such as three-, four- or other n-cornered cross-sections can be considered for the component feeds arranged coaxially one inside the other.

According to the invention, an outer feeding cavity is provided as the first component feed for supplying the first component from the component feed to the associated component discharge orifice.

Furthermore, an inner feeding cavity is provided as a second component feed to the associated component discharge orifice for providing the second component at the associated component discharge orifice.

The feeding cavities are cavities for the feed-through of the components.

The two components are supplied through the component feeds of the feeding cavities, for example, by a pump or a cylinder-piston unit.

At the component discharge orifices, the two components are extruding from the respective component discharge orifice of the respective feeding cavity to be subsequently mixed.

However, it can also be provided that the components sequentially extrude individually from the respective component discharge orifice of the respective feeding cavity so that, in addition to a cleaning effect, a separate unmixed application of only one of the components can take place. For example, PU glue or other suitable components intended for two-component mixtures can be processed, in which the application of only one of the components possible per se, is possible and takes place without a booster or the respective other component and the desired effect is still achieved.

According to the invention, the inner feeding cavity is enclosed by an inner feeding tube and the inner feeding tube is preferably arranged concentrically/coaxially in the outer feeding cavity, wherein the inner feeding tube is preferably evenly spaced from the cavity wall as the radially outer inner wall of the outer feeding cavity.

Thus, between the cavity wall of the outer feeding cavity, which is for example formed as an outer feeding tube or a bore, and the inner feeding tube, the outer feeding cavity is formed as a hollow space for the feed-through of the first component.

The two component discharge orifices may lie axially in one plane. Alternatively, the component discharge orifice of the outer feeding cavity projects axially above the component discharge orifice of the inner feeding tube. Accordingly, the component discharge orifice of the outer feeding cavity annularly surrounds the component discharge orifice of the inner feeding tube, i.e. the inner feeding cavity, which advantageously enables the mixing of the two components immediately after the component discharge orifices.

Equally alternatively, the component discharge orifice of the inner feeding cavity or the inner feeding tube may extend axially beyond the component discharge orifice of the outer feeding tube so as to facilitate access to the component discharge orifice of the inner feeding cavity, for example, for maintenance or cleaning.

Furthermore, by means of, for example, an appropriately shaped or designed mixing device, the supply of the first component at or around the component discharge orifice of the inner feeding tube can be facilitated.

If the two component discharge orifices lie axially in one plane, the valve rod tip can project axially from this plane of the two component discharge orifices or end in this plane.

According to the invention, a valve rod which is movable in the axial direction and connected to an actuator is arranged in the inner feeding tube. Accordingly, the hollow space forming the inner feeding cavity is formed between the inner feeding tube and the valve rod for the feed-through of the second component.

It is further provided that the valve rod is formed to correspond with a valve seat arranged at the component discharge orifice of the inner supply tube, and thus the valve rod forms a valve with the valve seat. For example, the valve rod can be formed for this purpose at the valve-side end or in the region of the valve seat or in a frustoconical or conical shape. Other cross-sections are also possible, for example, a cylindrical cross-section with axially flat or round or conically tapered ends.

In the direction of flow downstream of the component discharge orifices of the outer feeding cavity and the inner feeding tube, a mixing device connected to the applicator is arranged in which the two components extruding from the component discharge orifices are mixed.

Advantageously, the arrangement of the component discharge orifices of the outer feeding cavity and the feeding tube according to the invention can influence the supply of the second component, and the operation or position of the valve of the inner feeding tube can dispense or interrupt the supply of the second component.

Advantageously, in the event of a suspension of the application of the components, the discharge of the second component is interrupted so that, in the event of a further feed of the first component, the second component is drawn along, pushed along or carried along with the flowing first component at the component discharge orifice of the inner feeding tube through the annularly enclosing component discharge orifice of the outer feeding cavity and can thus be removed from the component discharge orifice of the inner feeding tube. Thus, an uncontrolled or undesired reaction of the components with each other at the component discharge orifices and thus, for example, a sticking or clogging at or in the region of the component discharge orifices or a sticking or clogging of the component discharge orifices can be advantageously avoided.

Advantageous designs of the invention are disclosed in the sub-claims.

According to a preferred design of the invention, it is provided that the component discharge orifice of the outer feeding cavity and the component discharge orifice of the inner feeding cavity lie axially in one plane. The axial plane is the plane perpendicular to the longitudinal axis of the at least two coaxially extending feeding cavities. Thus, the discharge orifice of the inner feeding tube, i.e. of the inner feeding cavity, is located in the same plane as the annular discharge orifice of the outer feeding cavity enclosing this discharge orifice.

Accordingly, in the event of suspension of the application of the components, as described above, the first component flowing out of the discharge orifice of the outer feeding cavity can discharge or displace the second component still adhering to the discharge orifice of the inner feeding tube from there and thus effectively prevent the uncontrolled or unwanted reaction of the two components with each other there.

According to an alternative further effect of the invention, it is provided that the outer feeding cavity with the component discharge orifice extends axially beyond the component discharge orifice of the inner feeding tube, i.e. the inner feeding cavity. By the second component remaining constricted or initially enclosed or surrounded by the second component after the exiting the discharge orifice of the inner feeding tube in its further course, an improved entrainment of the second component with the first component to the mixing device can be effected.

Alternatively or additionally, the continued constriction of the guidance of the first component can be done by a corresponding design of the mixing device in the region of the continuation of the outer feeding cavity.

According to a further preferred design of the invention, the outer feeding cavity is conically tapered in the region of the component discharge orifices, so that a section with a tapering is present. This design of the invention has a particularly advantageous effect when the tapering occurs in the section of the outer feeding cavity in which it extends beyond the component discharge orifice of the inner feeding tube.

The conical reduction of the cross-section of the outer feeding tube directs the first component to the inner feeding tube in the region downstream of the discharge orifice of the outer feeding tube, thereby advantageously improving entrainment of the second component from the discharge orifice of the inner feeding tube.

According to an advantageous effect of the invention, the mixing device is implemented as a static mixer. A static mixer is generally cylindrical in shape and comprises various guide elements in the interior deflecting the flow of the components in a multiple crossing manner, so that the components are mixed as a result. In this way, the components can be efficiently mixed immediately before application without external energy and moving parts.

According to a preferred design of the invention, the mixing device is detachably connected to the applicator, preferably to the outer wall or outer wall of the outer feeding cavity, by means of a screw thread or bayonet connection or clamp connection. The screw thread connection can advantageously be made by means of a union nut. In this way, a mixing device that meets the respective specific requirements can be quickly mounted in an advantageous manner. Likewise, stuck, clogged or worn mixing devices can be easily dismantled and cleaned or replaced.

Accordingly, the applicator in a basic design is advantageously also adaptable to different applications, in particular, to different components.

According to a further advantageous effect of the invention, the inner feeding tube is designed to be movable in the axial direction within the outer feeding cavity and is connected to an actuator. For this purpose, an inner valve seat is preferably formed in the outer feeding cavity on the cavity wall at the component discharge orifice, which corresponds to the outer wall at the component discharge orifice of the inner feeding tube.

Accordingly, the inner valve seat at the component discharge orifice of the outer feeding cavity forms a valve with the outer wall at the component discharge orifice of the inner feeding tube. Thus, the inner feeding tube is designed to be movable in analogy to the valve rod, so that the outflow of the first component via the outer feeding cavity can be controlled and, in particular, also interrupted via the valve thus realized.

In accordance with an embodiment of the invention, the actuators are advantageously designed with an electromechanical or hydraulic or pneumatic linear actuator or with a linear actuator designed in another way, so that the flow rates of the second component or of both components can be varied and, in particular, interrupted in cooperation with a control unit.

According to a preferred design of the invention, it is provided that in the course of the outer feeding cavity downstream the cross-section is reduced in a gradation or in a course. The reduction in cross-section is preferably a reduction in the internal diameter of the cavity wall of the outer feeding cavity. With the gradation and the thus reduced cross-section, it is achieved that the flow of the first component is unified. In addition, the respective volume flows can be adapted to each other by adjusting the cross-sections.

A reduction in cross-section can also be provided if the outer wall or the outer wall of the outer feeding cavity may not exceed a predetermined diameter, for example, for structural reasons, so that at least the outer feeding cavity is designed or dimensioned accordingly. In this case, further adaptations and designs or dimensioning of the inner feeding cavity may also result.

According to an advantageous effect, the inner feeding tube and/or the cavity wall of the outer feeding cavity are composed of several parts. Accordingly, a glued or worn section of the inner feeding tube and/or the cavity wall of the outer feeding cavity can be replaced in an advantageous manner. Likewise, different cross-sections of the component discharge orifices can be easily implemented by replacing the sections that can be detached from each other.

Thus, the outer feeding cavity or the cavity wall of the outer feeding cavity may be machined out of a block or machined out of the block and supplemented with tubes or tube sections or composed of tubes or tube sections.

Accordingly, the cavity wall of the outer feeding cavity can, for example, be formed by a tube or be made by one or more bores in the applicator block or in the housing of the applicator.

According to a further preferred design of the invention, the valve stem tip and/or the outside of the valve seat or the outside of the component discharge orifice of the inner feeding tube has a generally flow-favorable contour. Accordingly, when the valve is closed, the valve rod tip together with the outside of the component discharge orifice of the inner feeding tube or with the outside of the valve seat of the inner feeding tube forms a conical or hemispherical or spherical segment-shaped contour. Accordingly, the valve stem tip is cone-shaped or hemispherical or spherical segment-shaped. The outside of the component discharge orifice or the outside of the valve seat of the inner feeding tube have a truncated cone shape or a spherical segment shape.

Due to the formed conical or hemispherical or spherical segment shape, the flow of the first component is guided to the valve rod tip without stalling or turbulence thereof, so that the second component adhering there is entrained with the first component and thus discharged therefrom in a particularly advantageous manner to prevent an uncontrolled or undesired reaction of the components.

Furthermore, the invention relates to an operating procedure or using the proposed or claimed applicator. Accordingly, a first component of at least two mixable components is conveyed through an outer feeding cavity surrounded by a cavity wall from a component feed to a component discharge orifice. Further, a second component of at least two components mixable with one another is conveyed through an inner feeding cavity formed in an inner feeding tube from a feed side to a component discharge orifice. Downstream of the component discharge orifice, the components are conveyed through a mixing device.

According to the invention, it is provided that an interruption of the feed of the second component through the inner feeding cavity is effected by means of a valve provided for this purpose at the associated discharge orifice before the interruption of the feed of the first component through the outer feeding cavity. In this way, in the event of an interruption in the application of the components, the second 20 component can be removed from the area of the discharge orifices by being carried along with the further conveyed first component. Accordingly, an uncontrolled or undesired reaction of the components with each other can be avoided there in an advantageous manner.

According to a preferred design of the invention, the feeding of the second component is terminated or interrupted by closing a valve at the component discharge orifice. The valve is closed by moving the valve rod towards the valve seat by means of an actuator, so that the discharge orifice of the inner feeding tube is closed and thus the second component can no longer exit there. By still further feeding the first component, the second component still present or adhering to the component discharge orifice of the inner feeding tube is carried along in an advantageous manner, so that only one single component and not at least two components reacting with each other are present at the valve seat or at the valve of the inner feeding tube, and thus contamination, adhesions or blockages and possibly destruction of the applicator are avoided.

According to an advantageous effect of the invention, the feeding of the first component through the outer cavity is continued until the second component is removed from the component discharge orifice of the inner feeding tube. Alternatively or additionally, the feeding of the first component through the outer feeding cavity may continue until the second component or a mixture of the first component and the second component is removed from a mixing device. In this way, a long and reliable service life of the applicator and/or of a subsequent mixing device is provided. Fulfilment of the condition to stop feeding the first component may be based, for example, on measurable or known volumetric flow rates or flow velocities of the components, or on empirical values, or may be determined by a suitable sensor system.

Advantageously, by continuing to feed the first component at the same time as feeding the second component or with a delay after feeding the second component, the uneven distributions and quantities of components upstream and downstream of the mixing device and the irregular or disturbed component mixing ratios created by the staggered interruption of the feeding of the components can be compensated for.

### BRIEF DESCRIPTION OF THE DRAWINGS

Several examples of the invention are shown in the drawings and are described in more detail below. The following is shown:

FIG. 1—a basic design of an applicator with a mixing device in a sectional view,

FIG. 2—a special application-related version of an applicator with a mixing device in a sectional view,

FIG. 3—an applicator with open valve in a sectional view and FIG. 4 an applicator with closed valve in a sectional view,

FIG. 4—an applicator with open valve in a sectional view and FIG. 4 an applicator with closed valve in a sectional view.

### DETAILED DESCRIPTION OF THE PREFERRED EMBODIMENTS

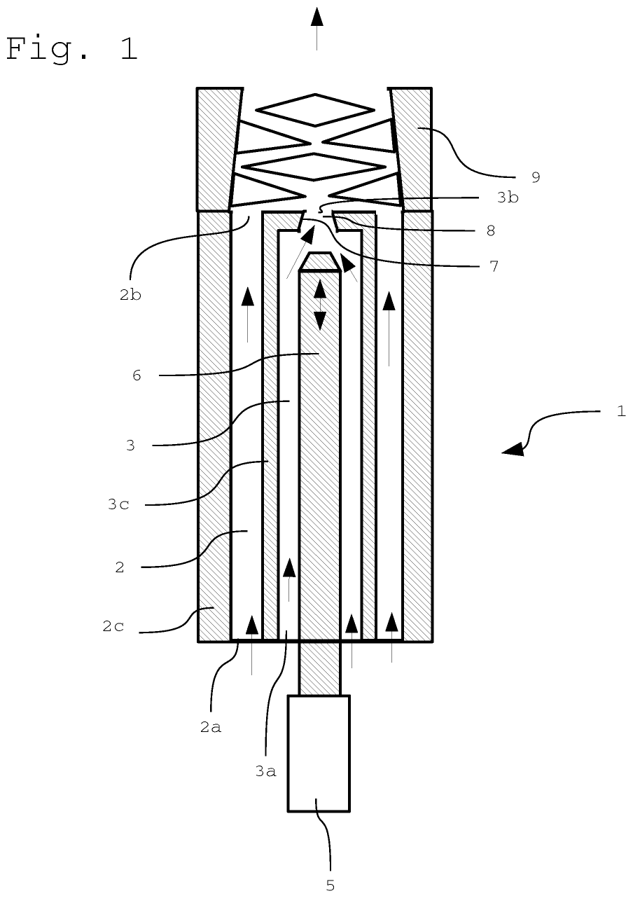

FIG. 1 shows a possible basic design of an applicator 1 with a schematically shown mixing device 9 in a sectional view.

The basic design comprises the essential features of the applicator 1 according to the invention.

The applicator 1 serves to feed two components separately and in a fixed dose combination to a mixing device 9 arranged at the component discharge orifices 2b, 3b of the feeding cavities 2, 3 separately supplying the components. The aim is to prevent the components brought together directly at the component discharge orifices 2b, 3b from reacting with each other during downtimes.

Component feeds 2, 3 designed as feeding cavities 2, 3 are provided for feeding the components separately. According to the invention, the inner feeding cavity 3 is arranged concentrically (coaxially) within the outer feeding cavity 2 in an inner feeding tube 3c. The outer feeding cavity 2 is closed off to the outside by a wall as a cavity wall 2c, which is designed here as a tube.

The feeding cavities 2, 3 are each supplied/loaded with the components through the component feeds 2a, 3a. The components exit from the feeding cavities 2, 3 at the respective component discharge orifices 2b, 3b.

According to the invention, it is provided that a valve 8 is formed in the inner feeding cavity 3, specifically at the component discharge orifice 3b, which enables the discharge of the second component to be separately interrupted/interrupted/stopped.

Due to the further supply of the first component, the second component, which does not continue to extrude from the component discharge orifice 3b, is entrained by the associated discharge orifice 3b through the first component and thus removed, so that no uncontrolled or undesired reaction of the components with each other can take place there in an advantageous manner and thus, for example, adhesion of the discharge orifices 2b, 3b is effectively and reliably avoided.

Depending on the specific process, the interruption of the supply of the second component takes place in good time before the application of the component mixture by means of the applicator 1 according to the invention is suspended, so that the second component is entrained by the associated discharge orifice 3b through the first component and is thus removed.

Depending on the process, a complete removal of the mixture of the first component and the second component from the mixing device can also take place by correspondingly continuing the supply of the first component through the outer supply cavity 2.

The valve 8 at the component discharge orifice 3b of the second component is realized in that a valve rod 6, which is movable in the axial direction and connected to an actuator 5, is arranged in the inner feeding tube 3c enclosing the inner feeding cavity 3 and corresponds to a valve seat 7 arranged at the component discharge orifice 3b of the inner feeding tube 3c. Thus, the valve rod 6 and the valve seat 7 form the valve 8 for interrupting the discharge of the second component. The actuator 5 is designed with an electromechanical, hydraulic or pneumatic drive and can preferably be controlled by a control unit (not shown).

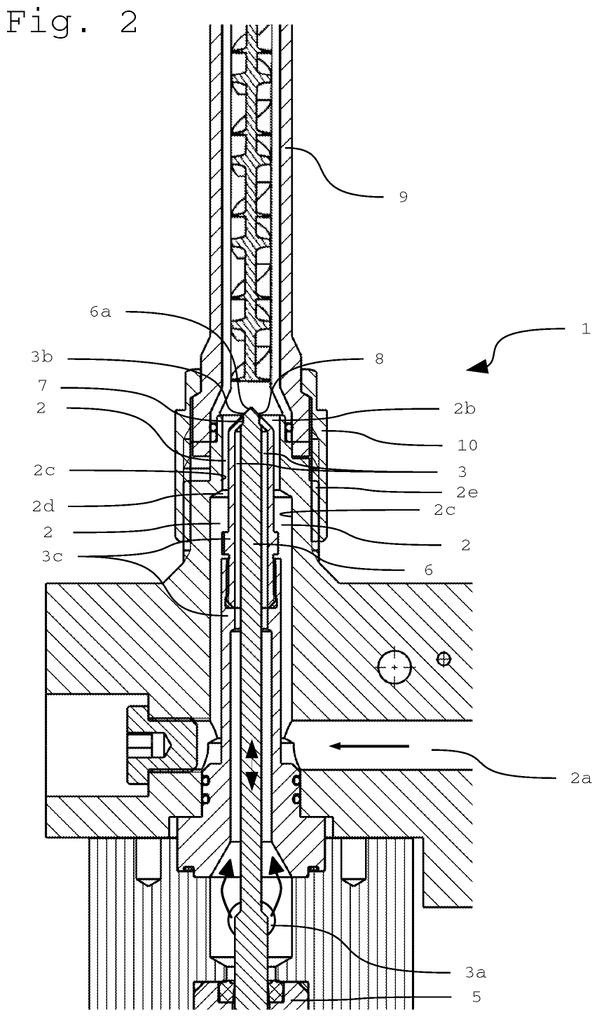

FIG. 2 shows an application-related (special) version of an applicator 1 according to the invention with a mixing device 9 in a sectional view. The essential elements of the applicator 1 shown are known from FIG. 1.

FIG. 2 shows the applicator 1 with a closed valve 8 arranged at the component discharge orifice 3b of the second component.

Here the outer feeding cavity 2 is realized as a bore in an applicator block, so that the applicator block forms the cavity wall 2c of the outer feeding cavity 2.

A further special feature of the embodiment shown here is that the mixing device 9 is designed as a static mixer 9.

The attachment of the static mixer 9 is implemented here with a union nut 10 screwed onto the outer wall or the outer wall 2e of the outer feeding cavity 2.

FIG. 2 shows the applicator 1 with a closed valve 8 arranged at the component discharge orifice 3b of the second component and thus of the inner feeding cavity 3 with valve rod 6, tip of the valve rod 6a, and valve seat 7.

The component discharge orifice 3b of the inner feeding tube 3 c forms the hollow-cylindrical valve seat 7, which corresponds with the cylindrical outer side of the valve rod 6. Thus, the axially movable valve rod 6 with the valve seat 7 forms the valve 8 that can interrupt the supply of the second component.

The inner feeding tube 3c shown here is designed in two parts, so that the front part with the associated component discharge orifice 3b and the valve seat 7 formed there can be replaced separately, for example, due to wear or changing requirements.

Furthermore, the outer feeding cavity 2 is formed with a gradation 2d and thus with a reduction in cross-section in the direction of flow. The gradation 2d is realized by the cavity wall 2c of the outer feeding cavity 2. The flow velocity is adjusted by the gradation 2d of the outer feeding cavity 2.

The tip 6a of the valve rod 6 is here cone-shaped and, when the valve 8 is closed, forms a cone-shaped closure together with the outside of the inner feeding tube 3c in the area of the component discharge orifice 3b.

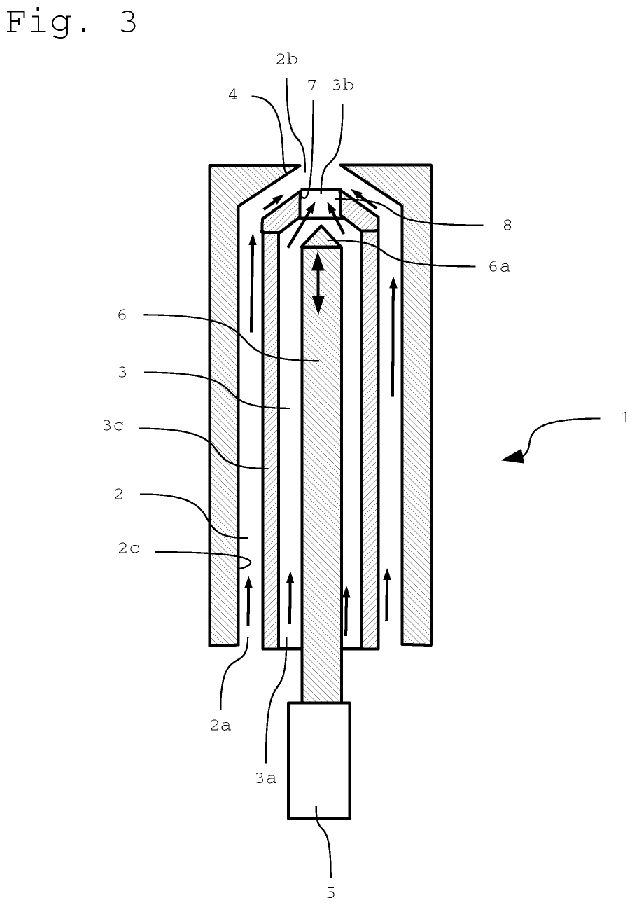

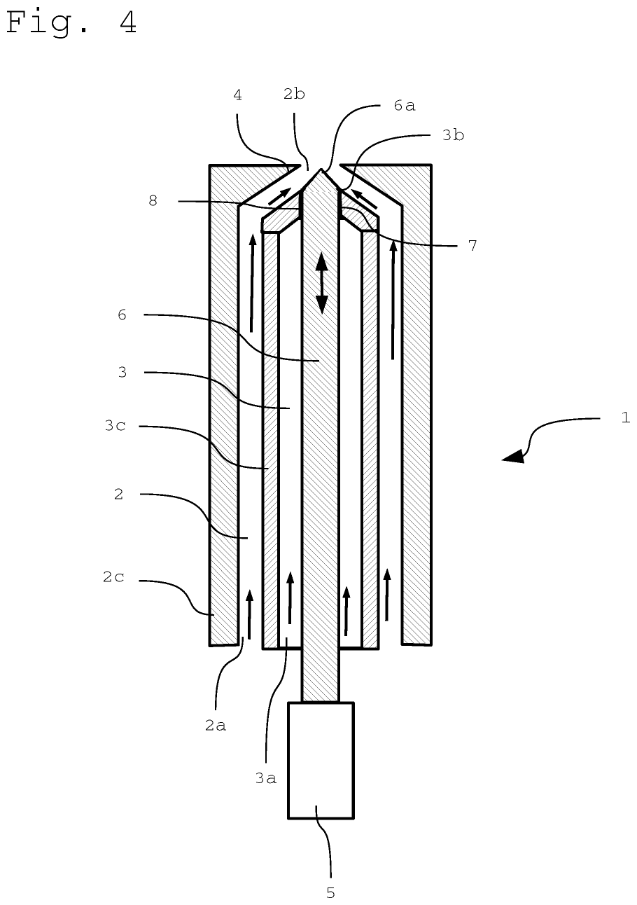

FIG. 3 and FIG. 4 show the applicator 1 known from FIG. 2 in a simplified concept sketch.

The feature of the cone formed jointly by the valve rod tip 6a and inner feeding tube 3 c is shown with valve 8 open in FIG. 3 and with valve 8 closed in FIG. 4. The mixing device is not shown in FIG. 3 and FIG. 4.

Due to the cone formed by the inner feeding tube 3 c together with the tip 6a of the valve rod 6 in the area of the component discharge orifice 3b (see FIG. 4) and the exemplary additional taper 4 of the cross-section of the outer feeding cavity 2 at the component discharge orifice 2b, the first component extruding from the component discharge orifice 2b is directed in an accelerated manner to the component discharge orifice 3b of the inner feeding tube 3, so that second component still adhering there, in particular, to the tip 6a of the valve rod 6, is entrained and thus cleaning of the tip 6a of the valve rod 6 in the region of the component discharge orifice 3b is advantageously carried out and thus the problem underlying the invention is advantageously solved.

The prevailing counter-pressure of a static mixer as a mixing device favorably ensures that the first component is directed to the component discharge orifice 3b of the inner feeding tube 3 even without an additional tapering section of the cross-section of the outer feeding cavity 2 at the component discharge orifice 2b, where it entrains or skim second component still adhering to the tip 6a of the valve rod 6. This design, which is shown, in particular, in FIG. 2, is also advantageous for cleaning the tip 6a of the valve rod 6 in the region of the component discharge orifice 3b, and the problem underlying the invention is advantageously solved.

According to the invention, an operating procedure or using the applicator 1 is further provided, wherein, in the specific embodiment example, a first component of at least two components which can be mixed with one another is conveyed from a component feed 2a to a component discharge orifice 2b through an outer feeding cavity 2 surrounded by a wall 2c, and a second component of the two components which can be mixed with one another is conveyed from a component feed 3a to a component discharge orifice 3b through an inner feeding cavity 3 formed in an inner feeding tube 3c. An interruption of the feed of the second component through the inner feeding cavity 3 occurs before the interruption of the feed of the first component through the outer feeding cavity 2 by means of a valve 8 at the component discharge orifice 3b of the inner feeding cavity 3, so that the first component clears or cleans the outer surfaces of the valve 8 at the component discharge orifice 3b of the inner feeding cavity 3 of the second component by displacing or pushing away this second component.

Advantageously, feeding of the first component through the outer feeding cavity 2 continues until the second component is reliably removed from the component discharge orifice 3b of the inner feeding cavity 3.

When the application is resumed, the feeding of the first component is continued simultaneously with the feeding of the second component or delayed after the feeding of the second component.

### LIST OF REFERENCE NUMERALS

1—applicator/application device
2—outer feeding cavity, outer component feed 5 2a—component feed for outer feeding cavity
2a—component feed for outer feeding cavity
2b—component discharge orifices of outer feeding cavity
2c—cavity wall of outer feeding cavity
2d—gradation of outer feeding cavity, change in cross-section
2e—outer wall, outer wall of outer feeding cavity
3—inner feeding cavity, inner component feeder
3a—component feed, inner feeding cavity
3b—component discharge orifice of the inner feeding cavity
3c—inner feeding tube, inner feeding cavity wall
4—taper
5—actuator for valve rod
6—valve rod
6a—tip of valve rod, valve rod tip
7—valve seat
8—valve
9—Mixing device
10—Union nut

1. Applicator/application device (1) for the application of at least two components which can be mixed with one another, comprising coaxially arranged one within the other component feeds (2, 3) with the component feeds (2a, 3a) for the respective at least two components and component discharge orifices (2b, 3b) associated with the component feeds (2, 3),
where
an outer feeding cavity (2) as the first component feed (2) to the associated 10 component discharge orifice (2b) for providing the first component, and
an inner feeding cavity (3) is provided as a second component feed (3) to the associated component discharge orifice (3b) for providing the second component,
wherein the inner feeding cavity is enclosed by an inner feeding tube (3c) disposed in the 15 outer feeding cavity (2) and is connected to a cavity wall (2c) of the outer feeding cavity (2) with a separation distance and
a valve rod (6) which can move in the axial direction and is connected to an actuator (5) is arranged in the inner feeding tube (3 c), wherein the valve rod (6) and/or the valve rod tip (6a) thereof corresponds with a valve seat (7) arranged at the component discharge orifice (3b) of the 20 inner feeding tube (3) and the valve rod (6) or the valve rod tip (6a), respectively, forms a valve (8) with the valve seat (7) and the inner feeding cavity (3) is formed between the inner feeding tube (3c) and the valve rod (6) and
a 25 mixing device (9) is arranged downstream of the component discharge orifices (2b, 3b) of the feeding cavities (2, 3).

2. The applicator according to claim 1,
characterized in
that the component discharge orifice (2b) of the outer feeding cavity (2) and the 30 component discharge orifice (3b) of the inner feeding cavity (3) lie axially in one plane, the valve rod tip (6a) also terminating in this plane or the valve rod tip (6a) projecting axially beyond this plane.

3. The applicator according to claim 1,
characterized in
that the outer feeding cavity (2) with the component discharge orifice (2b) extends axially beyond the component discharge orifice (3b) of the inner feeding tube (3c) or that the component discharge orifice (3b) of the inner feeding tube (3c) or the inner feeding tube extends axially beyond the outer feeding cavity (2) with the component discharge orifice (2b).

4. Applicator according to claim 1,
characterized in
that the cross-section of the outer feeding cavity (2) is conically tapered in the region of the component discharge orifices (2b, 3b).

5. Applicator according to claim 1,
characterized in
that the mixing device (9) is a static mixer (9).

6. Applicator according to claim 1,
characterized in
that the mixing device (9) is detachably connected to the wall (2c) of the outer feeding cavity (2) by means of a screw thread or bayonet connection or by means of a clamp connection.

7. Applicator according to claim 1,
characterized in
that the inner feeding tube (3c) is formed within the outer feeding cavity (2) so as to be movable in the axial direction and is connected to an actuator, and the outer feeding cavity (2) is formed on the inside at the component discharge orifice (2b) with an inner valve seat which corresponds to the inner feeding tube (3c), and
the inner valve seat forms a valve with the inner feeding tube (3c).

8. Applicator according to claim 1,
characterized in
that the actuators (5) are formed with an electromechanical or hydraulic or pneumatic drive.

9. Applicator according to claim 1,
characterized in
that in the course of the outer cavity (2) downstream the cross-section is reduced in a gradation (2d).

10. Applicator according to claim 1,
characterized in
that the inner feeding tube (3c) and/or the cavity wall of the outer feeding cavity (2c) are composed of several parts.

11. Applicator according to claim 1,
characterized in
that the valve rod tip (6a) together with the outside of the component discharge orifice (3b) or with the outside of the valve seat (7) of the inner feeding tube (3c) when the valve (8) is closed forms a conical or hemispherical contour.

12. An operating procedure or using an applicator (1) according to claim 1, wherein a first component of at least two components which can be mixed with one another is conveyed through an outer feeding cavity (2) surrounded by a wall (2c) from a component feed (2a) to a component discharge orifice (2b), and a second component of the two components which can be mixed with one another is conveyed through an internal feeding cavity (3) formed in an internal feeding tube (3c) from a component feed (3a) to a component discharge orifice (3b) and wherein downstream of the component discharge orifice (2b) and the component discharge orifice (3b) the components are passed through a mixing device (9), wherein
an interruption of the feed of the second component through the inner feeding cavity (3) takes place with a time delay before the interruption of the feed of the first component through the outer feeding cavity (2).

13. The applicator's (1) operating procedure according to claim 12,
characterized in
that the interruption of the feed of the second component is effected by closing the valve (8) at the component discharge orifice (3b) of the inner feeding cavity (3).

14. The applicator's (1) operating procedure according to claim 12,
characterized in
that the feeding of the first component through the outer feeding cavity (2) is continued until the second component is removed from the component discharge orifice (3b) of the inner feeding cavity (3) or that the feeding of the first component through the outer feeding cavity (2) is continued until the second component or a mixture of the first component and the second component is removed from the mixing device (9).

15. The applicator's (1) operating procedure according to claim 12,
characterized in
that the continuation of the feeding of the first component is simultaneous with the feeding of the second component or delayed after the feeding of the second component.
